(19) United States
(12) Patent Application Publication
(10) Pub. No.: US 2014/0360936 A1
(43) Pub. Date: Dec. 11, 2014

(54) REMOVAL OF DISSOLVED SALTS USING A SOLVENT

(71) Applicant: Christopher Taylor, Winona, TX (US)

(72) Inventor: Christopher Taylor, Winona, TX (US)

(21) Appl. No.: 14/298,696

(22) Filed: Jun. 6, 2014

Related U.S. Application Data
(60) Provisional application No. 61/832,342, filed on Jun. 7, 2013.

(51) Int. Cl. C02F 1/26; C02F 1/06; B01D 1/00

(52) U.S. Cl. CPC C02F 1/265; B01D 1/0011; C02F 1/06; C02F 2101/12
USPC 210/636; 210/638; 210/177; 210/634; 210/141

(57) ABSTRACT

The present disclosure is related to a method and apparatus for reducing a salt concentration in a liquid composition using a solvent. The method includes combining the liquid composition and the solvent, where the solvent has lower carrying capacity for at least one salt in solution with the liquid composition. The liquid composition may be miscible with the solvent. The solvent may also have a lower boiling point than the liquid composition. The method further includes precipitating some of the salt out of the liquid and removing the precipitate. The solvent may then be separated, leaving the liquid composition with a reduced salt concentration. The solvent may be reused if recovered after separation. The apparatus includes elements for implementing the method.

### BACKGROUND OF THE DISCLOSURE

1. Field of the Disclosure

The present disclosure relates to a method and apparatus of removing dissolved salts from a liquid using a solvent, and, in particular, a method and apparatus of removing the dissolved salts from production water using an organic solvent.

2. Description of the Related Art

Hydraulic fracturing generally involves the fracturing of rock layers using pressurized liquid. A common liquid used in hydraulic fracturing is water. Various sediments, salts, and other impurities may be contained in the water after the fracturing is performed. Prior to release into the environment, the “frac water” may be processed to remove at least some of the impurities.

Generally, purification may be used to remove unwanted or harmful substances from water. Common purification techniques include reverse osmosis filtration and distillation. These techniques are often used for purification of drinking water. Both reverse osmosis and distillation require energy to separate the unwanted substances, such as excess salts and minerals, from the water. When large quantities of water (such as frac water) require some degree of impurity removal, reverse osmosis and distillation operations may be vecry energy, and thus cost, intensive. What is needed is a purification process that will remove select impurities from the water that does not have the substantial energy requirements of reverse osmosis and distillation.

### BRIEF SUMMARY OF THE DISCLOSURE

In aspects, the present disclosure is related to removing dissolved salts from a liquid using a solvent, and, in particular, removing the dissolved salts from frac water using an organic solvent.

One embodiment according to the present disclosure includes a method of removing at least part of at least one dissolved salt from a liquid composition, the method comprising the steps of: combining a first quantity of the liquid composition and a quantity of a second solvent, the liquid composition comprising: a first solvent, and the at least one dissolved salt; precipitating the amount of the at least one dissolved salt out of the liquid composition, wherein the first solvent has a carrying capacity for the at least one dissolved salt that is greater than the carrying capacity of the second solvent for the at least one dissolved salt; removing the at least part of the at least one dissolved salt from contact with the first quantity of the liquid composition and second solvent; and separating the second solvent from the first quantity of the liquid composition. The separating step may comprise flashing the second solvent off of the first quantity. The method may also include one or more of: i) removing particulates from the first quantity, ii) destroying microorganisms in the first quantity, iii) removing a layer from the first quantity, and iv) recovering the separated second solvent. The recovered second solvent may be added to a second quantity of the liquid composition or added to another liquid composition comprising a third solvent and another at least one dissolved salt. The method may also include estimating a size of the second solvent quantity. The estimate of the size of the quantity of the second solvent may include using an algorithm based on the carrying capacity of the first solvent for the at least one dissolved salt and the carrying capacity of the second solvent for the at least one dissolved salt. The quantity of the second solvent may be based on a desired amount of that at least one dissolved salt remaining in the first quantity of the liquid composition after precipitation. The second solvent may comprise at least one organic solvent. The at least one organic solvent may be acetone and ethanol. The at least one organic solvent may comprise at least one alcohol. The at least one alcohol may be one or more of ethanol and methanol. The at least one dissolve salt may comprise at least one of sodium chloride and potassium chloride. The liquid composition may be frac water.

Another embodiment according to the present disclosure may include a method for removing a dissolved salt, the method comprising: combining a solvent with frac water, the frac water comprising water and the dissolved salt, wherein the solvent comprises at least one of: ethanol and methanol; precipitating at least part of the salt from the solution; removing the precipitate from contact with the frac water and the solvent; flashing off the solvent from the water and the unprecipitated salt; and recovering the flashed solvent.

Another embodiment according to the present disclosure may include a method of extracting a dissolved salt out of a quantity of a liquid composition, the method comprising the steps of: precipitating at least part of the dissolved salt out of the quantity of the liquid composition using a quantity of a second solvent with a lower carrying capacity than a carrying capacity of a first solvent in the liquid composition; removing the precipitated salt from contact with the liquid composition and the second solvent; separating the second solvent quantity from the quantity of the liquid composition; and recovering the second solvent quantity. The precipitating step may comprise combining the liquid composition and the second solvent. The separating step may comprise flashing the second solvent off of the first quantity. The method may include one or more of: i) adding the separated second solvent to a second quantity of the liquid composition, ii) adding the separated second solvent to another liquid composition comprising a third solvent and another at least one dissolved salt, iii) removing particulates from the first quantity, iv) destroying microorganisms in the first quantity, v) removing a layer from the first quantity, and vi) estimating a size of the second solvent quantity. The estimation of the size of the second solvent quantity may include using an algorithm based on the carrying capacity of the first solvent for the at least one dissolved salt and the carrying capacity of the second solvent for the at least one dissolved salt. The size of the quantity of the second solvent may be based on a desired amount of that at least one dissolved salt remaining in the first quantity of the liquid composition after precipitation.

Another embodiment according to the present disclosure includes an apparatus for removing dissolved salts from a liquid composition, the system comprising: a container configured to store a quantity of the liquid composition, the liquid composition comprising a first solvent and at least one dissolved salt; a controller configured to add a predetermined quantity of a second solvent to the container; a controller configured to estimate the predetermined quantity of the second solvent based on a selected output salt concentration; a salt removal means configured to remove a precipitated salt from the container; a heater in thermal communication with the second solvent and configured to separate the second solvent from the liquid composition after the precipitated salt has been removed; and a recovery container configured to store the separated second solvent. The controller may be configured to receive the selected output salt concentration. The predetermined quantity of the second solvent may be estimated by an algorithm based on the carrying capacity of the first solvent for the at least one dissolved salt and the carrying capacity of the second solvent for the at least one dissolved salt. The apparatus may also include one or more of: i) a filter configured to remove the particulate from the first quantity, ii) a biocide, and iii) a skimming means for removing a layer from the first quantity.

Another embodiment according to the present disclosure may include a method of reducing a salt concentration in a liquid composition, the method comprising: estimating a quantity of a second solvent required to be combined with a quantity of the liquid composition to reduce the salt concentration of the liquid composition to a selected level after the second solvent has been separated from the liquid composition. The method may also include estimating an amount of energy required to separate the second solvent from the liquid composition by flashing off the second solvent and combining the estimated quantity of the second solvent with the quantity of the liquid composition when the amount of energy is less than or equal to an amount of energy required for an alternative salt removal operation, such as distillation or reverse osmosis. The method may also include precipitating the amount of the at least one, dissolved salt out of the liquid composition; removing the at least part of the at least one dissolved salt from contact with the first quantity and the second solvent; and separating the second solvent from the first quantity of the liquid composition. The method may also include one or more of: i) adding the separated second solvent to a second quantity of the liquid composition, ii) adding the separated second solvent to another liquid composition comprising a third solvent and another at least one dissolved salt, iii) removing a particulate from the first quantity, iv) destroying microorganisms in the first quantity, and v) removing a layer from the first quantity.

Another embodiment according to the present disclosure may include a non-transitory computer-readable medium product, the medium comprising instructions thereon that, when executed by a processor, perform a method, the method comprising: estimating a quantity of a second solvent required to be combined with a quantity of a liquid composition to reduce a salt concentration of the liquid composition to a selected level after the second solvent has been separated from the liquid composition. The method may also include estimating an amount of energy required to separate the second solvent from the liquid composition by flashing off the second solvent; and transmitting an instruction to combine the estimated quantity of the second solvent with the quantity of the liquid composition when the amount of energy is less than or equal to an amount of energy required for an alternative salt removal operation.

Examples of the more important features of the disclosure have been summarized rather broadly in order that the detailed description thereof that follows may be better understood and in order that the contributions they represent to the art may be appreciated. There are, of course, additional features of the disclosure that will be described hereinafter and which will form the subject of the claims appended hereto.

### BRIEF DESCRIPTION OF THE DRAWINGS

For a detailed understanding of the present disclosure, reference should be made to the following detailed description of the embodiments, taken in conjunction with the accompanying drawings, in which like elements have been given like numerals, wherein:

FIG. 1A is a diagram of a container holding a liquid composition with dissolved salts and a separately stored solvent according to one embodiment of the present disclosure;

FIG. 1B is a diagram of the container holding a mixed liquid composition of the liquid composition and stored solvent of FIG. 1A to one embodiment of the present disclosure;

FIG. 1C is a diagram of a container holding the mixed liquid composition of FIG. 1B as salts precipitate out of the mixed liquid composition according to one embodiment of the present disclosure;

FIG. 1D is a diagram of a container holding the mixed liquid composition of FIG. 1C after the precipitated salts have been removed according to one embodiment of the present disclosure;

FIG. 1E is a diagram of a container as the solvent is separated to leave behind the original liquid composition of FIG. 1A minus the precipitated salts according to one embodiment of the present disclosure;

FIG. 2 is a flow chart of a method of reducing a salt concentration of a liquid composition according to one embodiment of the present disclosure; and

FIG. 3 is a flow chart of another method of reducing salt concentration of a liquid composition according to one embodiment of the present disclosure.

FIG. 4 is diagram for an apparatus for educing a salt concentration of a liquid composition according to one embodiment of the present disclosure;

FIG. 5 is a flow chart for performing an estimate of an amount of solvent to be added to a liquid composition to reduce a salt concentration of the liquid composition to a selected value according to one embodiment of the present disclosure;

FIG. 6 is a flow chart for performing an estimate of an amount of salt that will be precipitated when an amount of solvent is added to an amount of a liquid composition according to one embodiment of the present disclosure; and

FIG. 7 is a schematic of a computer system configured to implement the method of FIG. 2 according to one embodiment of the present disclosure.

### DETAILED DESCRIPTION OF THE DISCLOSURE

Generally, the present disclosure relates to removing dissolved salts from a liquid using a solvent, and, in particular, removing the dissolved salts from production water using an organic solvent. The present disclosure is susceptible to embodiments of different forms. They are shown in the drawings, and herein will be described in detail, specific embodiments of the present disclosure with the understanding that the present disclosure is to be considered an exemplification of the principles of the present disclosure and is not intended to limit the present disclosure to that illustrated and described herein.

At a specified temperature, two different solvents may have different carrying capacities or solubilities. For example, in pure water at 298.15 degrees Kelvin, the water may hold a mass fraction of 26.476 percent of potassium chloride in solution. Ethanol, at the same 298.15 degrees Kelvin may only hold a mass fraction of 0.034 percent of potassium chloride in solution. In some instances, combined solvents, such as water and ethanol, may have a lower combined carrying capacity than the individual contributions to carrying capacity by the solvents. A combination of 50 percent water and 50 percent ethanol by mass has a combined carrying capacity for potassium chloride of 6.198 percent, which is less than the carrying capacity of the separate water and ethanol (26.476%*50%+0.034%*50%=13.255%).

Combining pure ethanol with a solution of water saturated with potassium chloride may result in the precipitation of some of the salt out of the solution because the carrying capacity of the combined water and ethanol may be less than the salt that is dissolved in the water before combination. Since, the combined water and ethanol cannot retain the 13.238 percent mass fraction of potassium chloride (26.476*50%+0*50%), but only 6.198 percent, the remaining potassium chloride will precipitate out of the solution. Salt that could not be easily removed while in solution may be removed as a solid once precipitated.

The solvents may be separated after salt removal, such that one solvent is removed and recovered for reuse and the other solvent retains the unprecipitated salts. The amount of salt removed may be a function of the amount of energy that the user desires to expend. For example, if the goal is to reduce the concentration of potassium chloride in water by adding a quantity of removable ethanol, then the amount of remaining potassium chloride will be a function of the carrying capacity of a solution of water and ethanol for potassium chloride and the amount of energy required to remove the ethanol from the solution.

In another example, one kilogram of pure water at 298.15 degrees Kelvin may include 300 grams of sodium chloride in solution. The maximum carrying capacity of one kilogram of pure water at 298.15 degrees Kelvin is 360 grams for sodium chloride, thus the water is not fully saturated. Under the same conditions, one kilogram of a combination of 80 percent acetone and 20 percent ethanol (80/20 solvent) may only have a carrying capacity of 0.130 grams for sodium chloride. The use of an 80/20 ratio of acetone to ethanol is illustrative and exemplary only, as other ratios to the two solvents may be used. A combination of 25 percent water and 75 percent 80/20 solvent has a combined carrying capacity for sodium chloride of about 22.4 grams per kilogram. Thus, the four kilograms of the solution could hold about 89.6 grams of sodium chloride. The remaining 210.4 grams of sodium chloride would precipitate out of the solution. Thus 70.1 percent of the original 300 grams of sodium chloride may be removed as precipitate, and after separations of the acetone and ethanol from the water (such as through flashing), the remaining sodium chloride-water solution will have 89.6 grams of sodium chloride in one kilogram of water, or 29.9 percent of the original 300 grams of sodium chloride in solution.

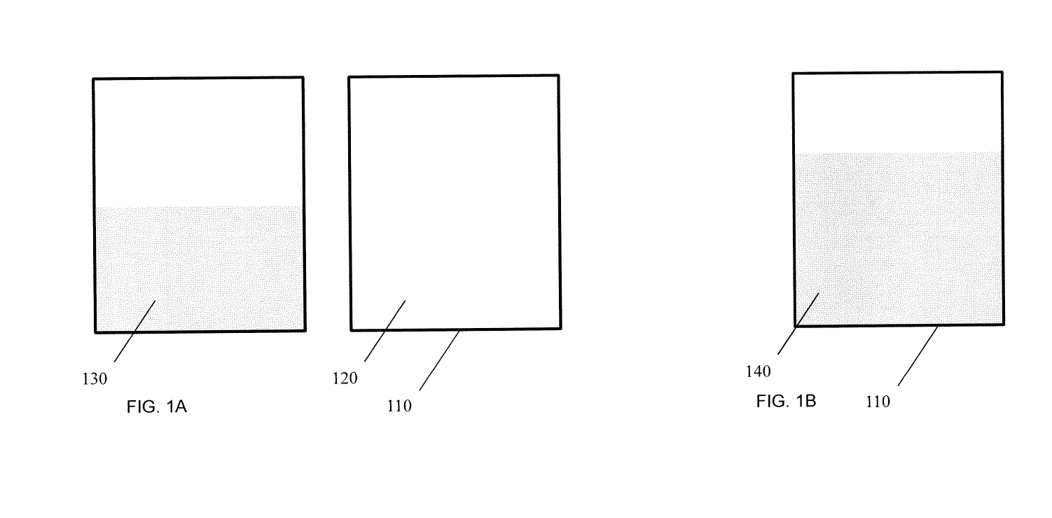

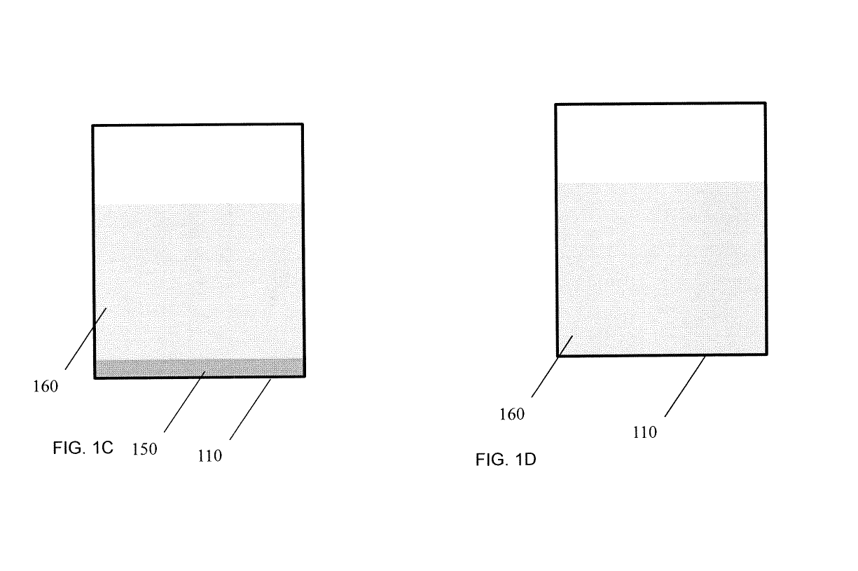

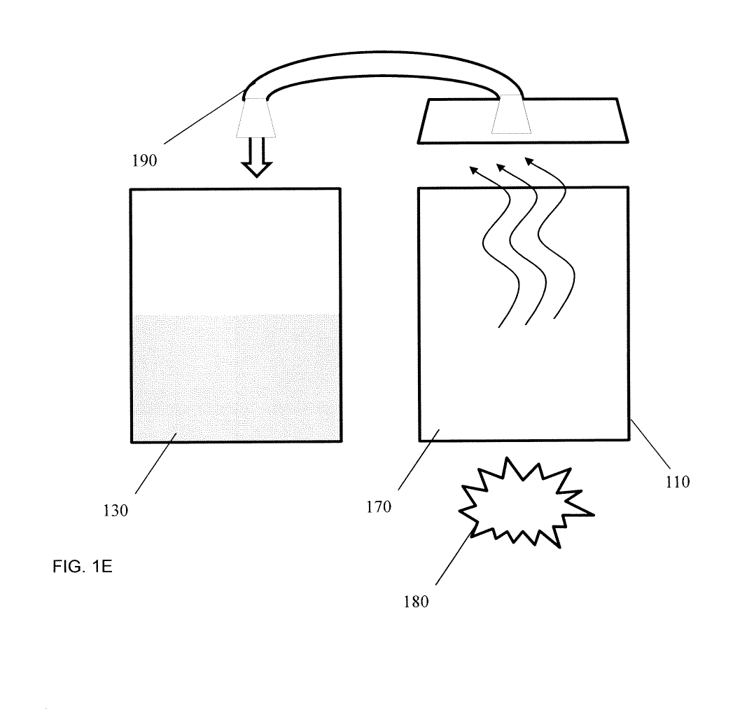

FIG. 1A shows a diagram of a first container 110 holding a quantity of a liquid composition 120 according to one embodiment of the present disclosure. The liquid composition 120 may comprise a first solvent and one or more dissolved salts. In some embodiments, the liquid composition 120 may be frac water. Also shown is a quantity of a second solvent 130. The quantity of the second solvent 130 maybe selected based on the quantity of the liquid composition 120, the concentration of dissolved salts in the liquid composition 120, and a target concentration of dissolved salts in the first solvent. The target concentration of dissolved salts may be lower than the concentration of dissolved salts in the liquid composition 120. The second solvent 130 may have a carrying capacity for the dissolved salts that is lower than the carrying capacity of the first solvent that is in the liquid composition 120. The second solvent 130 may have a boiling point that is lower than the first solvent.

The second solvent 130 may include an inorganic solvent or an organic solvent. Suitable organic solvents may include, but are not limited to, one or more of: i) alcohol, ii) acetaldehyde, iii) acetonitrile, iv) dimethoxyethane, v) ethanol, vi) ethylamine, vii) methanol, viii) methyl isocyanide, ix) isopropyl alcohol, and x) tetrahydrofuran. Suitable inorganic solvents may include, but are not limited to, one or more of: i) dimethylhydrazine, ii) unsymmetrical dimethylhydrazine, hydrofluoric acid, and iv) nitric acid. In some embodiments, the dissolved salts may include one or more of: i) sodium chloride and ii) potassium chloride. As would be understood by a person of ordinary skill in the art with the benefit of the present disclosure, some the substances that may serve as the second solvent may also be suitable as a first solvent in second combination, so long as the second solvent in the second combination i) has a lower boiling point than the boiling point of the first solvent, i) has a lower carrying capacity for the salt than the carrying capacity for the salt of the first solvent, and iii) is miscible with the first solvent. For example, ethanol and acetone may both be used as the second solvent with water (first solvent), and acetone may also be used as a second solvent with ethanol (first solvent).

In some embodiments, the second solvent may include a combination of solvents, such as a mixture of acetone (dimethyl ketone) and ethanol. As discussed above, the combined solvent has a lower boiling point than the first solvent, a lower carrying capacity for the salt than the carrying capacity of the first solvent, and is miscible in the first solvent. In some embodiments, the combination may include two solvents that individually are not fully miscible in the first solvent but are fully miscible when the first solvent and the combined solvent are combined. In one exemplary embodiment, the second solvent may be a combined solvent of acetone and ethanol. In another embodiment, the combined solvent may be 80 percent acetone and 20 percent ethanol and the first solvent may be water.

The first container 110 may be any form of containment configured to hold the liquid composition 120 and will not chemically react with either the liquid composition 120 or the second solvent 130. Generally, the first container 110 may be any suitable reactor vessel. Suitable reactor vessels may include, but is not limited to, i) a barrel, ii) a flask, iii) a pit, iv) a subterranean cavern, v) a tank, and vi) a borehole. The first container 110 may be sealed or open to the environment.

FIG. 1B shows a diagram of a second liquid composition 140 that is made up of the combination of the liquid composition 120 and the second solvent 130. Due to the differences in the carrying capacities of the first solvent and the second solvent 130, excess salt may precipitated out of solution.

FIG. 1C shows a diagram of a precipitated salt 150 that has separated from a liquid composition 160. The liquid composition 160 may include the first solvent, the second solvent 130, and the unprecipitated salts that have remained in solution.

FIG. 1D shows a diagram of the liquid composition 160 after the precipitated salts 150 have been removed from the first container 110. The precipitated salts 150 may be removed by any means known to a person of ordinary skill in the art so long as the removal prevents the salts from reentering the liquid composition 160, including, but not limited to, gravity driven draining, dredging, raking, and scooping.

FIG. 1E shows a diagram of the liquid composition 160 being separated. Here, the second solvent 130 is shown being removed through a heating process, such as flashing, where a heat source 180 boils off the second solvent 130. The post-flashing remainder may be a liquid composition 170 that comprises the first solvent and the unprecipitated salts. The second solvent 130 may be collected by a collection device 190 for reuse or disposal.

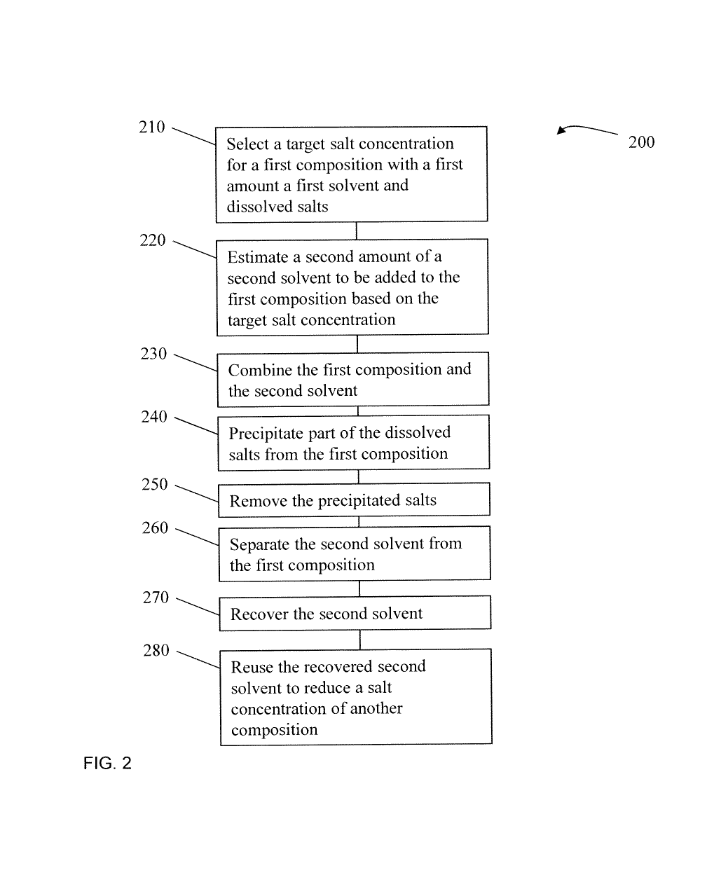

FIG. 2 shows an exemplary method 200 for reducing salt content of a solution according to one embodiment of the present disclosure. In step 210, a target salt concentration of the liquid composition 120 may be selected. The target salt concentration is lower than the starting salt concentration of the liquid composition 120. In step 220, a quantity of a second solvent 130 is estimated for addition to a quantity of the liquid composition 120. The estimation may include using an algorithm based on the carrying capacities of the first solvent and the second solvent 130. The estimation may also be based on the quantity of dissolved salts in the first composition 120 (starting salt concentration). The estimation may be based on the type of salt or salts that are dissolved in the liquid composition 120. In some embodiments, steps 210 and 220 may be optional. In some embodiments, the algorithm may include an estimate of the amount of energy required to perform the method 200. In some embodiments, the algorithm may include a comparison between the estimated amount of energy and the energy requirements of alternatives to method 200 for reducing a dissolved salt concentration, such as reverse osmosis and distillation.

In step 230, the first composition 120 and the second solvent 130 may be combined to form a mixed liquid composition 140. The mixed liquid composition 140 may be formed when the second solvent 130 may be added to the liquid composition 120; the liquid composition 120 may be added to the second solvent 130; or the second solvent 130 and the liquid composition 130 may be mixed simultaneously in a separate container. In step 240, at least part of the dissolved salts may precipitated out of the mixed liquid composition 140 to form a precipitate 150 and a remaining mixed liquid composition 160. In step 250, the precipitate 150 may be removed from the first container 110. In step 260, the second solvent 130 may be removed from the remaining mixed liquid composition 160. The separation step may be performed by flashing off the second solvent 130 from the remaining mixed liquid composition 160. Flashing is may be performed by applying heat to the remaining mixed liquid composition 160 until the second solvent 130 boils off. In some embodiments, the flashing of the second solvent 130 may be performed at ambient temperatures (additional heat source not required). As would be understood by one of ordinary skill in the art, the second solvent 130 may have a lower evaporation temperature than then first solvent, such that the unprecipitated salts remain dissolved in the first solvent. After the second solvent 130 is removed, the remaining liquid composition 170 may include the first solvent and the unprecipitated salts in solution. The use of a flashing technique to separate the second solvent 130 from the remaining liquid composition 170 is illustrative and exemplary only, as other separation techniques known to persons of ordinary skill in the art with the benefit of the present disclosure may be used. In some embodiments, the type of heat source 180 and/or the amount of heat used in the separation process may be selected based on the amount of energy required for dissolved salt removal or water purification alternatives.

In step 270, the second solvent 130 may be recovered from the separation process. In step 280, the recovered second solvent 130 may be reused. In some embodiments, the reuse may include mixing with a second quantity of the liquid composition 120 to reduce salt concentration or with in another liquid composition. In some embodiments, steps 270 and 280 are optional. The precipitated salts 150 from step 250 may also be used, such that the method 200 may also be used as an extraction process for removing salts from a solution.

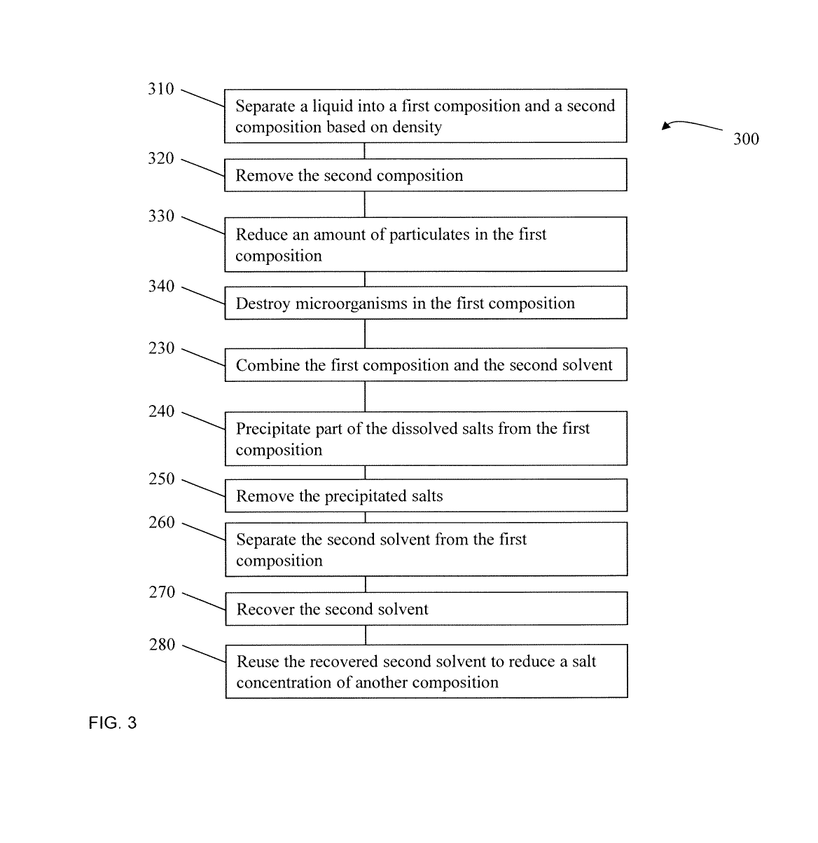

FIG. 3 shows a flow chart of another exemplary method 300 for reducing salt content of a liquid according to the present disclosure. Here, the liquid may also include, in addition to liquid composition 120, impurities other than dissolved salts, such as a non-miscible second composition in mixture, microorganisms, and particulates. The particulates may include undissolved substances that are soluble or have the potential to be soluble in the first solvent and/or substances that do not dissolve into solution with the first solvent.

In step 310, the mixture of the first liquid composition 120 and the second liquid composition may be separated. Being non-miscible, the first composition 120 and second composition may separate due to differences in density. In step 320, the separated second composition may be removed from contact with the first composition 120. The removal may be performed by skimming the second composition off of the first composition 120 (if the second composition is less dense than the first composition 120). The use of skimming as a removal technique is exemplary and illustrative only, as other separation techniques known to persons of ordinary skill in the art with the benefit of the present disclosure may be used as well. In step 330, the amount of particulates in the first composition 120 may be reduced. The reduction of particulates may be performed by filtering the first composition 120 or other suitable techniques known to persons of ordinary skill in the art.

In step 340, microorganisms present in the first composition 120 may be destroyed. The destruction of the microorganisms may be performed by adding a biocide. The use of a biocide is exemplary and illustrative only, as other techniques, such as, but not limited to, exposing the first composition 120 to lethal radiation, may be used. Steps 230 through 280 from method 200 may be performed as a part of method 300. Any of steps 310 through 340 may be optional. Steps 310 and 320, step 330, and step 340 may be performed in any order, including after and during steps 230 through 280. In some embodiments, the destruction of microorganisms in step 340 may be performed by the addition of the second solvent 130 in step 230, if the second solvent 130 is selected to have biocidal properties. In some embodiments, the biocide in step 340 and the second solvent 130 may be selected to destroy different types of microorganisms.

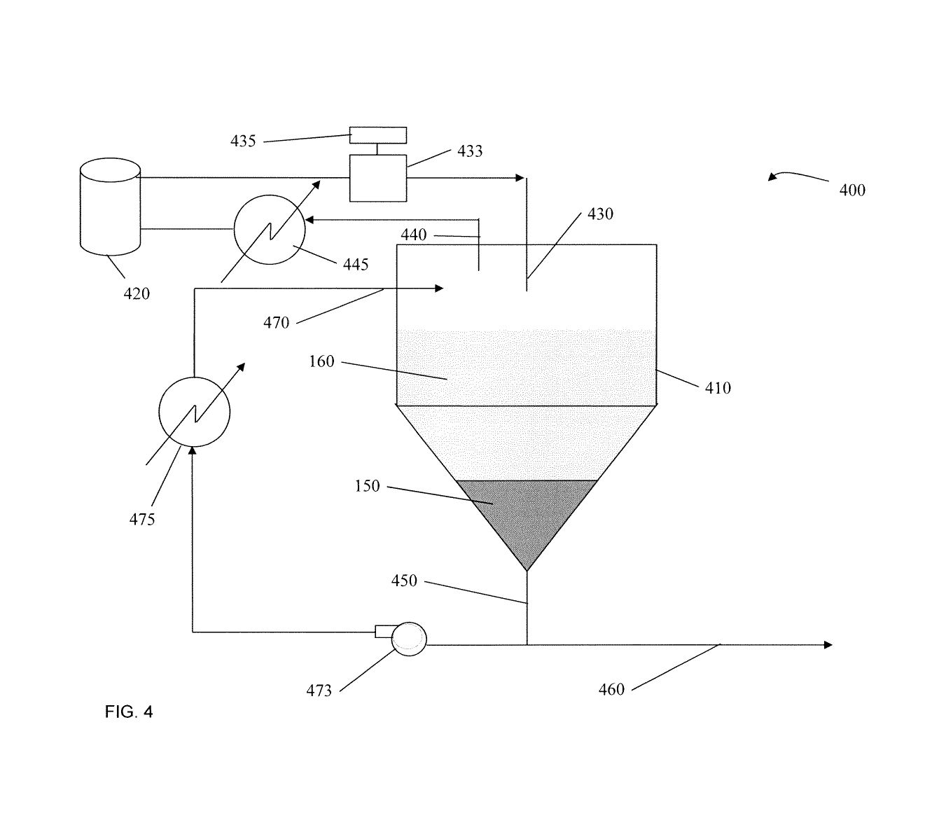

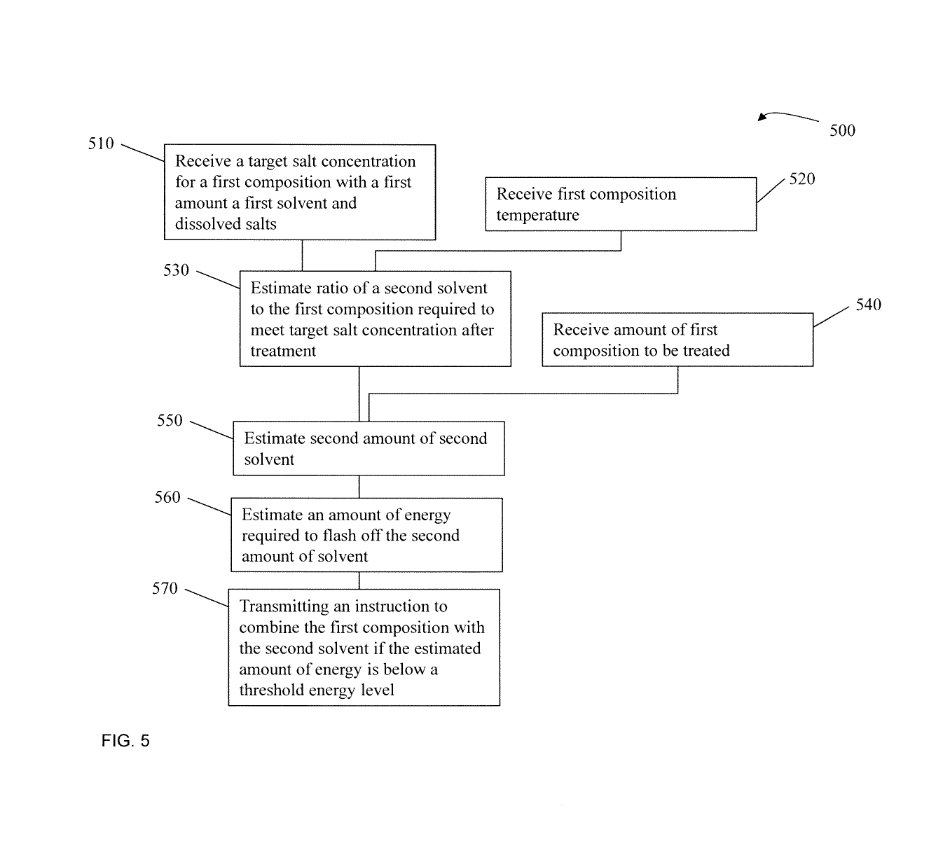

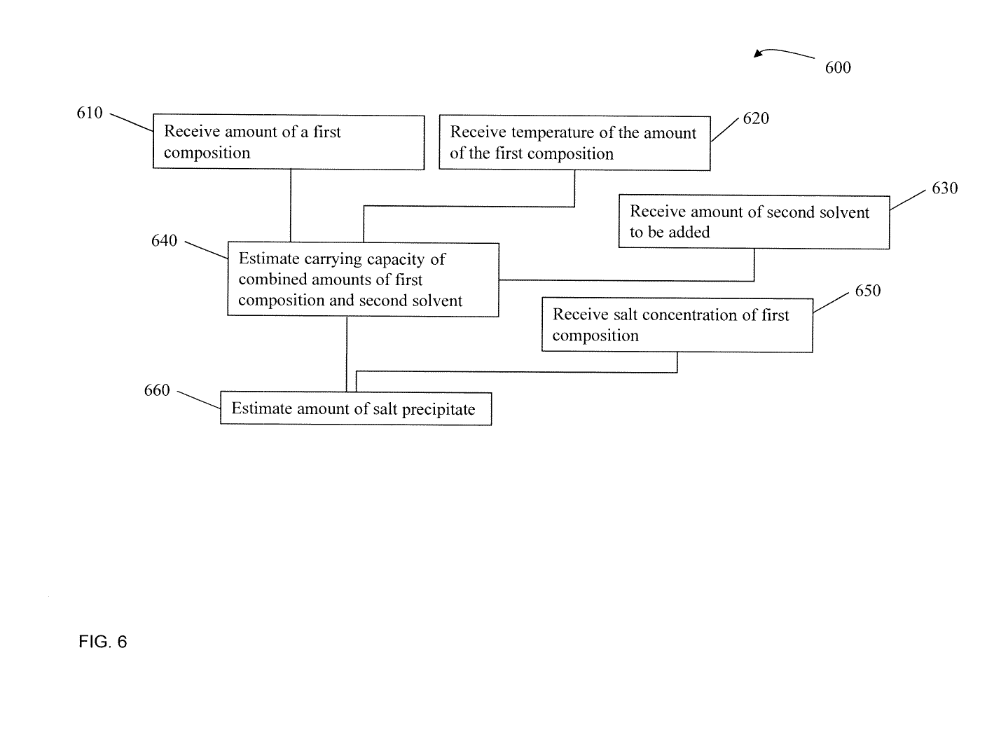

FIG. 4 shows a diagram of an exemplary apparatus 400 for removing salt from the liquid composition 120. The apparatus 400 may include a container 410 configured to hold a mixture of the second solvent 130 and the liquid composition 120. The second solvent 130 may be stored in a storage vessel 420 and conveyed through the pipe 430 to the container 410. A controller 433 may regulate the amount of solvent 130 that is conveyed into container 410. A controller 435 may estimate the amount of solvent 130 that is to be conveyed into the container 410 and transmit the estimate to the controller 433. The controller 435 may estimate the amount of solvent to be added and/or an amount of precipitated salt 150 to be removed by, using an equation, executing an algorithm (see FIG. 5 and FIG. 6), or using a table. The controller 433 and the controller 435 may share an information processor or have separate information processors. As shown, the salt has precipitated from he mixture 140. The salt precipitate 150 may collect at the bottom of the container 410 as the mixture 140 separates into the precipitate 150 and the mixture 160 comprising the first solvent, the unprecipitated salt, and the second solvent 130. The precipitate 150 may be removed from the container 410 through a pipe 450, The use of gravity driven removal of the precipitate 150 from a container 410 is exemplary and illustrative only, as other removal techniques may be used alternatively or in addition to gravity driven removal, such as, but not limited to, dredging and raking.

The removal process may include some of the mixture 160, so the mixture 160 and the precipitate 150 may be separated. The salt precipitate 150 is removed via the pipe 460, while the mixture 160 is recirculated into the container 410 via the pipe loop 470. If some of the mixture 160 is conveyed in the pipe 460, then additional recovery techniques, as would be understood by a person of ordinary skill in the art would understand with the benefit of the present disclosure, may be used to recapture the mixture 160. The pipe loop 470 may include a pump 473 to propel the mixture 160 and an optional heat exchanger 475. The heat exchanger 475 may be configured to add sufficient heat to the mixture 160 to boil the second solvent 130. In some embodiments, ambient temperatures may be sufficient for boiling off the second solvent 130 from the mixture 160 for recovery. A recovery pipe 440 may be disposed to capture the second solvent 130 when the second solvent 130 boils off from the mixture 160. The recovery pipe 440 may convey the second solvent 130 to the storage tank 420. A heat exchanger 445 may be disposed along the path from the recovery pipe 440 to the storage vessel 420 to recover heat energy from the second solvent 130. As shown storage vessel 420 may be part of the second solvent 130 supply and recovery aspects, however, in some embodiments, storage second solvent 130 prior to use and after recovery may be in two or more separate vessels.

FIG. 5 shows a flow chart of a method 500 for estimating a quantity of the second solvent 130 required to reduce the salt concentration of the liquid composition 120 to a selected level according to one embodiment of the present disclosure. In step 510, a target salt concentration for the remaining liquid composition 170 (first composition 120 after removal of the precipitated salt 150) may be received. In step 520, a temperature of the first composition 120 may be received. In step 530, a ratio of an amount of the second solvent 130 to be added to an amount of the first composition 120 in order to obtain the target salt concentration in the remaining liquid composition 170 may be estimated using the target salt concentration and the temperature of the first composition 120. The estimation may be performed using at least one of: i) an equation, ii) an algorithm, and hi) a table. In step 540, an amount of the first composition 120 may be received. In step 550, an amount of the second solvent 130 needed may be estimated based on the ratio from step 530 and the amount of the first composition 120 from step 540. In step 560, an amount of energy required to boil off the amount of the second solvent 130 may be estimated based on the composition and amount of the second solvent 130. In step 570, an instruction to combine the liquid composition 120 and the second solvent 130 if the estimated amount of energy is below a threshold level. The threshold level may be based on the energy requirements of alternative salt removal operations, such as distillation and reverse osmosis. In some embodiments, the instruction to combine may be sent to the controller 433. In some embodiments, steps 560 and 570 may be optional. In some embodiments, step 540 may be performed before step 530. Steps 510, 520, and 540 may be performed in any order.

FIG. 6 shows a flow chart of a method 600 for estimating a quantity of salt precipitated when an amount of the second solvent 130 is added to the liquid composition 120 according to one embodiment of the present disclosure. In step 610, an amount of the first composition 120 may be received. In step 620, a temperature of the first composition 120 may be received. In step 630, an amount of the second solvent 130 may be received. In step 640, the carrying capacity of the combined amounts of the first composition 120 and the second solvent 130 may be estimated. The estimation may be performed using at least one of: i) an equation, ii) an algorithm, and iii) a table. In step 650, a salt concentration of the first composition 120 may be received. In step 660, the quantity of precipitated salt 150 may be estimated. The estimation of the quantity of salt precipitated 150 may be based on i) the carrying capacity of the combined mixture of the first composition 120, ii) the second solvent 130 and the salt concentration of the first composition 120, and iii) the combined amounts of the first composition 120 and the second solvent 130. In some embodiments, step 650 may be performed before step 640. Steps 610, 620, 630, and 650 may be performed in any order.

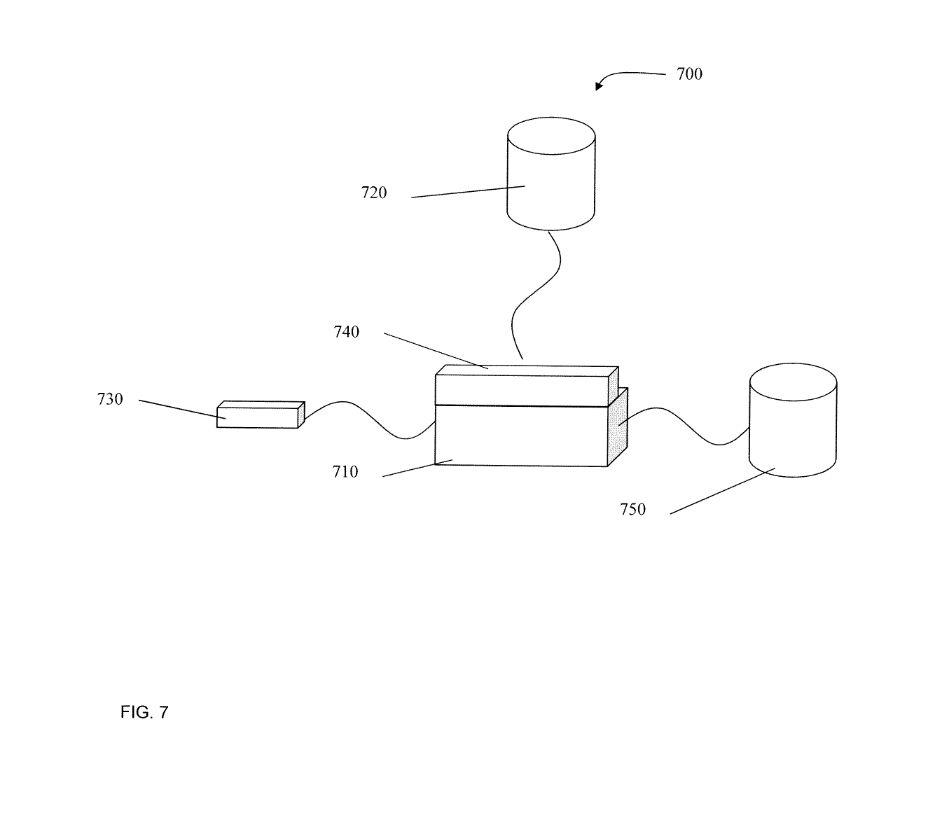

FIG. 7 shows a schematic of an exemplary hardware environment 700 where the method may be implemented according to the present disclosure. The hardware environment may include an information processor 710, a non-transitory computer-readable medium 720, an input device 730, a processor memory 740, and may include peripheral information storage medium 750. The hardware environment 700 may be located in a single location or distributed across multiple locations. The input device 730 may be any information reader or user input device, such as data card reader, keyboard, USB port, etc. The non-transitory computer-readable medium 720 may be any standard non-transitory computer information storage device, such as a ROM, USB drive, memory stick, hard disk, removable RAM, EPROMs, EAROMs, EEPROM, flash memories, and optical disks or other commonly used memory storage system known to one of ordinary skill in the art including Internet based storage. The non-transitory computer-readable medium 720 stores a program that when executed causes information processor 710 to execute the disclosed method, such as exemplary methods 200 and 300. The non-transitory computer-readable medium 720 may also store suitability data about the first party and/or suitability data about the plurality of insurance products. In some embodiments, the suitability data about the first party and/or the suitability data about the plurality of insurance products may be stored in a peripheral information storage medium 750, which may be any standard computer information storage device, such as a USB drive, memory stick, hard disk, removable RAM, or other commonly used memory storage system known to one of ordinary skill in the art including Internet based storage. The information processor 710 may be any form of computer or mathematical processing hardware, including Internet based hardware. When the program is loaded from the non-transitory computer-readable medium 720 into processor memory 740 (e.g. computer RAM), the program, when executed, causes information processor 710 to retrieve the suitability data from either the non-transitory computer-readable medium 720 or the peripheral information storage medium 750 and to process the information to perform the suitability analysis and/or provide the insurance product to the first party.

While the disclosure has been described with reference to exemplary embodiments, it will be understood that various changes may be made and equivalents may be substituted for elements thereof without departing from the scope of the disclosure. In addition, many modifications will be appreciated to adapt a particular instrument, situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

What is claimed is:

1. A method of removing at least part of at least one dissolved salt from a liquid composition, the method comprising the steps of:
combining a first quantity of the liquid composition and a quantity of a second solvent, the liquid composition comprising:
a first solvent, and
the at least one dissolved salt;
precipitating an amount of the at least one dissolved salt out of the liquid composition, wherein the first solvent has a carrying capacity for the at least one dissolved salt that is greater than the carrying capacity of the second solvent for the at least one dissolved salt;
removing the at least part of the at least one dissolved salt from contact with the first quantity of the liquid composition and second solvent; and
separating the second solvent from the first quantity of the liquid composition.

2. The method of claim 1, wherein the separating step comprises:
flashing the second solvent off of the first quantity.

3. The method of claim 1, further comprising:
recovering the separated second solvent.

4. The method of claim 3, further comprising:
adding the separated second solvent to a second quantity of the liquid composition.

5. The method of claim 3, further comprising:
adding the separated second solvent to another liquid composition comprising a third solvent and another at least one dissolved salt.

6. The method of claim 1, further comprising:
estimating a size of the second solvent quantity, wherein the size of the second solvent quantity is estimated by an algorithm based on the carrying capacity of the first solvent for the at least one dissolved salt and the carrying capacity of the second solvent for the at least one dissolved salt.

7. The method of claim 1, wherein a size of the quantity of the second solvent is based on a desired amount of that at least one dissolved salt remaining in the first quantity of the liquid composition after precipitation.

8. The method of claim 1, wherein the liquid composition further comprises a particulate; and the method further comprises:
removing the particulate from the first quantity.

9. The method of claim 1, wherein the liquid composition further comprises a microorganism; and the method further comprises:
destroying the microorganism in the first quantity.

10. The method of claim 1, wherein the liquid composition further comprises a first layer and a second layer; and the method further comprises:
removing the second layer from the first quantity.

11. The method of claim 1, wherein the second solvent comprises at least one organic solvent.

12. The method of claim 11, wherein the at least one organic solvent comprises acetone and ethanol.

13. The method of claim 11, wherein the at least one organic solvent comprises at leas one alcohol.

14. The method of claim 13, wherein the at least one alcohol comprises at least one of: ethanol and methanol.

15. The method of claim 1, wherein the at least one dissolved salt comprises at least one of:
sodium chloride and potassium chloride.

16. The method of claim 1, wherein the liquid composition is frac water.

17. An apparatus for removing dissolved salts from a liquid composition, the system comprising:
a container configured to store a quantity of the liquid composition, the liquid composition comprising a first solvent and at least one dissolved salt;
a controller configured to add a predetermined quantity of a second solvent to the container;
a controller configured to estimate the predetermined quantity of the second solvent based on a selected output salt concentration;
a salt removal means configured to remove a precipitated salt from the container;
a heater in thermal communication with the second solvent and configured to separate the second solvent from the liquid composition after the precipitated salt has been removed; and
a recovery container configured to store the separated second solvent.

18. The apparatus of claim 17, wherein the controller is configured to receive the selected output salt concentration.

19. The apparatus of claim 17, wherein the predetermined quantity of the second solvent is estimated by an algorithm based on the carrying capacity of the first solvent for the at least one dissolved salt and the carrying capacity of the second solvent for the at least one dissolved salt.

20. The apparatus of claim 17, wherein the liquid composition further comprises a particulate; and the apparatus further comprises:
a filter configured to remove the particulate from the first quantity.

21. The apparatus of claim 17, wherein the liquid composition further comprises a microorganism; and the apparatus further comprises:
a biocide.

22. The apparatus of claim 17, wherein the liquid composition further comprises a first layer and a second layer; and the apparatus further comprises:
a skimming means for removing the second layer from the first quantity.

23. The apparatus of claim 17, wherein the second solvent comprises at least one organic solvent.

24. The apparatus of claim 23, wherein the at least one organic solvent comprises at least one alcohol.

25. The apparatus of claim 24, wherein the at least one alcohol comprises at east one of: ethanol and methanol.

26. The apparatus of claim 17, wherein the at least one dissolved salt comprises at least one of: sodium chloride and potassium chloride.

27. The apparatus of claim 17, wherein the liquid composition is frac water.

28. A method of reducing a salt concentration in a liquid composition, the method comprising:
estimating a quantity of a second solvent required to be combined with a quantity of the liquid composition to reduce the salt concentration of the liquid composition to a selected level after the second solvent has been separated from the liquid composition.

29. The method of claim 28, wherein the liquid composition comprises a first solvent and a salt, and wherein the estimation is based on the carrying capacity for the salt of the first solvent and the carrying capacity for the salt of the second solvent.

30. The method of claim 28, further comprising:
estimating an amount of energy required to separate the second solvent from the liquid composition by flashing off the second solvent;
combining the estimated quantity of the second solvent with the quantity of the liquid composition when the amount of energy is less than or equal to an amount of energy required for an alternative salt removal operation;
precipitating the amount of the at least one dissolved salt out of the liquid composition;
removing the at least part of the at least one dissolved salt from contact with the first quantity and the second solvent; and
separating the second solvent from the first quantity of the liquid composition.

31. The method of claim 28, wherein the alternative salt removal operation is one of: distillation and reverse osmosis.

32. A non-transitory computer-readable medium product, the medium comprising instructions thereon that, when executed by a processor, perform a method, the method comprising:
estimating a quantity of a second solvent required to be combined with a quantity of a liquid composition to reduce a salt concentration of the liquid composition to a selected level after the second solvent has been separated from the liquid composition.

33. The non-transitory computer-readable medium product of claim 32, wherein the liquid composition comprises a first solvent and a salt, and wherein the estimation is based on the carrying capacity for the salt of the first solvent and the carrying capacity for the salt of the second solvent.

34. The non-transitory computer-readable medium product of claim 32, further comprising:
storing the selected level.

35. The non-transitory computer-readable medium product of claim 32, further comprising:
estimating an amount of energy required to separate the second solvent from the liquid composition by flashing off the second solvent; and
transmitting an instruction to combine the estimated quantity of the second solvent with the quantity of the liquid composition when the amount of energy is less than or equal to an amount of energy required for an alternative salt removal operation.
